(19) United States
(12) Patent Application Publication
(10) Pub. No.: US 2008/0122827 A1
(43) Pub. Date: May 29, 2008

(54) DATA DRIVING INTEGRATED CIRCUIT FOR PLASMA DISPLAY PANEL AND PLASMA DISPLAY APPARATUS

(76) Inventor: Jeong-pil CHOI, Seoul (KR)

Correspondence Address: KED & ASSOCIATES, LLP, P.O. Box 221200, Chantilly, VA, 20153-1200, US

(21) Appl. No.: 11/935,608

(22) Filed: Nov. 6, 2007

(30) Foreign Application Priority Data
Nov. 29, 2006 (KR) 10-2006-0109665
Nov. 29, 2006 (KR) 10-2006-0119392
Feb. 12, 2007 (KR) 10-2007-0014493

(51) Int. Cl. G06F 3/038

(52) U.S. Cl. 345/212

(57) ABSTRACT

A data driving integrated circuit for a plasma display panel and a plasma display apparatus are disclosed. The data driving integrated circuit includes a first power input node for receiving a data voltage during an address period according to a data pulse, a second power input node for receiving a reference voltage during the address period, an output node to be connected to address electrodes, a connection terminal to be connected to a charging/discharging circuit for supplying or recovering charge/discharge currents to or from the address electrodes, and a first switching device for switching between the first power input node and the output node so that a voltage inputted to the first power input node or the second power input node is outputted to the address electrodes during the address period according to a data pulse.

This application claims the benefit of Korean Patent Application Nos. 10-2006-0109665, 10-2006-0119392 and 10-2007-0014493 filed on Nov. 7, 2006, Nov. 29, 2006 and Feb. 12, 2007, which is hereby incorporated by reference.

### BACKGROUND OF THE DISCLOSURE

1. Field of the Disclosure

This document relates to a data driving integrated circuit for a plasma display panel and a plasma display apparatus.

2. Description of the Related Art

A plasma display apparatus includes a plasma display panel and a driver for driving the plasma display panel.

The plasma display panel has the structure in which barrier ribs formed between a front panel and a rear panel forms unit discharge cell or a plurality of discharge cells. Each discharge cell is filled with an inert gas containing a main discharge gas such as neon (Ne), helium (He) or a mixture of Ne and He, and a small amount of xenon (Xe). The plurality of discharge cells form one pixel. For example, a red (R) discharge cell, a green (G) discharge cell, and a blue (B) discharge cell form one pixel. When the plasma display panel is discharged by applying a high frequency voltage to the discharge cell, the inert gas generates vacuum ultraviolet rays, which thereby cause phosphors formed between the barrier ribs to emit light, thus displaying an image. Since the plasma display apparatus can be manufactured to be thin and light, it has attracted attention as a next generation display device.

### SUMMARY OF THE DISCLOSURE

In an aspect, a data driving integrated circuit for a plasma display panel according to the present invention comprises: a first power input node for receiving a data voltage during an address period according to a data pulse; a second power input node for receiving a reference voltage during the address period; an output node to be connected to address electrodes; a connection terminal to be connected to a charging/discharging circuit for supplying or recovering charge/discharge currents to or from the address electrodes; a first switching device for switching between the first power input node and the output node so that a voltage inputted to the first power input node or the second power input node is outputted to the address electrodes during the address period according to a data pulse; a second switching device for switching between the second power input node and the output node; and a third switching device for connecting the connection terminal and the output node if the voltage inputted to the address electrodes from the first power input node or the second power input node is in a high impedance state.

The connection terminal may be connected to one end of a resonance forming unit, and the other end of the resonance forming unit may be serially connected to an energy storage unit with one end grounded.

The connection terminal may be connected to the other end of the energy storage unit with one end grounded.

The data driving integrated circuit may comprise a module control unit controls a charging/discharging circuit for supplying or recovering charge/discharge currents to or from an address electrode by determining whether there is an operation for supplying or recovering charge or discharge currents according to a data signal.

If the data signal is different from the previous data signal, the data driving integrated circuit may supply or recover charge or discharge currents, while if the data signal is identical to the previous data signal, the data driving integrated circuit may not supply or recover charge or discharge currents.

In another aspect, a data driving integrated circuit for a plasma display panel according to the present invention comprises: a third power input node for selectively receiving a data voltage and a reference voltage during an address period according to a data pulse; a fourth power input node for receiving a bias voltage lower than the data voltage and higher than the reference voltage during the address period; an output node to be connected to address electrodes; a fourth switching device for switching between the third power input node and the output node so that the data voltage or the reference voltage is outputted to the address electrodes during the address period according to a data pulse; and a fifth switching device for switching between the fourth power input node and the output node so that a bias voltage can be outputted to the address electrodes if the fourth power switching device is turned off.

The third power input node may be connected to one end of a data power switching device and one end of a reference voltage switching device, respectively.

The other end of the data power switching device may be connected to a data power source for supplying a data voltage, and the other end of the reference voltage switching device may be grounded.

In still another aspect, a plasma display apparatus according to the present invention comprises: a plasma display panel including a first address electrode and a second electrode; a data driving integrated circuit including a first data driving circuit module and a second data driving module, the first data driving circuit module for supplying a first data voltage and a second data voltage to the first address electrode during an address period according to a first data pulse, and forming a path for supplying or recovering charge or discharge currents to or from the first address electrode, and the second data driving circuit module for supplying a data voltage or a reference voltage to the second address electrode during the address period according to a second data pulse, and forming a path for supplying or recovering charge or discharge currents to or from the second address electrode; and a module control unit for controlling the data driving integrated circuit such that charge or discharge currents for forming a second data pulse may be supplied to the second address electrode before recovering charge or discharge currents for forming a first data pulse from the first electrode according to a data signal, or such that charge or discharge currents for forming a first data pulse may be recovered from the first electrode before recovering charge or discharge currents for forming a second data pulse from the second address electrode according to a data signal.

The plasma display apparatus may comprise an energy storage unit which is connected to a data driving integrated circuit to supply or recover charge or discharge currents for forming a first data pulse and a second data pulse to or from the first address electrode and second address electrode.

The plasma display apparatus may comprise a resonance forming unit which is positioned between the data driving integrated circuit and the energy storage unit and resonates charge or discharge currents for forming a first data pulse and a second data pulse to supply or recover the same to or from the first address electrode and second address electrode.

If the data signal is different from the previous data signal, the data driving integrated circuit may supply or recover charge or discharge currents, while if the data signal is identical to the previous data signal, the data driving integrated circuit may not supply or recover charge or discharge currents.

The first data pulse and the second data pulse may overlap with each other.

The first data pulse and the second data pulse each comprise a rising period for rising from a second data voltage to a first data voltage, a sustaining period for sustaining the first data voltage, and a falling period for falling from the first data voltage to the second data voltage. The rising period of the second data pulse may start before the falling period of the first data pulse.

The first data driving circuit module and the second data driving circuit module each comprises: a first power input node for receiving a first data voltage during an address period according to a first data pulse and a second data pulse; a second power input node for receiving a second data voltage during the address period; an output node to be connected to address electrodes; a connection terminal to be connected to a charging/discharging circuit for supplying or recovering charge/discharge currents to or from the address electrodes; a first switching device for switching between the first power input node and the output node so that a voltage inputted to the first power input node or the second power input node can be outputted to the address electrodes during the address period according to a first data pulse and a second data pulse; a second switching device for switching between the second power input node and the output node; and a third switching device for connecting the connection terminal and the output node if the voltage inputted to the address electrodes from the first power input node or the second power input node is in a high impedance state.

The first data voltage may be substantially higher than 50 V and lower than 70 V, and the second data voltage may be substantially higher than the ground voltage level and lower than the first data voltage.

The data driving integrated circuit for a plasma display panel and the plasma display apparatus according to one embodiment of the present invention can provide a simple circuit configuration and minimize a driving power by recovering the energy of the data driving circuit.

Furthermore, the data driving integrated circuit for a plasma display panel and the plasma display apparatus according to one embodiment of the present invention can improve driving efficiency and reduce heat generation and power consumption by improving the data driving circuit module.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 is a view for explaining a plasma display apparatus according to one embodiment of the present invention;

FIG. 2 is a view for explaining some parts of a data driver according to one embodiment of the present invention;

FIG. 3 is a view for explaining a data driving integrated circuit for a plasma display panel according to a first embodiment of the present invention;

FIG. 4 is a view for explaining the operation of the data driving integrated circuit for a plasma display panel according to the first embodiment of FIG. 3;

FIG. 5 is a view for explaining a data driving integrated circuit for a plasma display panel according to a second embodiment of the present invention;

FIG. 6 is a view for explaining the operation performed by the data driving integrated circuit for a plasma display panel according to the second embodiment of FIG. 5;

FIG. 7 is a view for explaining a data driving integrated circuit for a plasma display panel according to a third embodiment of the present invention;

FIG. 8 is a view for explaining the operation performed by the data driving integrated circuit for a plasma display panel according to the third embodiment of FIG. 7;

FIG. 9 is a view for explaining a module control unit according to one embodiment of the present invention;

FIG. 10 is a view for explaining a data driving integrated circuit for a plasma display panel according to a fourth embodiment of the present invention.;

FIG. 11 is a view for explaining the operation performed by the data driving integrated circuit for a plasma display panel according to the fourth embodiment of FIG. 10;

FIG. 12 is a view for explaining another operation performed by the data driving integrated circuit for a plasma display panel according to the fourth embodiment of the present invention;

FIG. 13 is a view showing a data pulse according to one embodiment of the present invention; and

FIG. 14 is a view for explaining a structure of a plasma display panel in a plasma display apparatus according to one embodiment of the present invention.

### DETAILED DESCRIPTION OF EMBODIMENTS

Reference will now be made in detail embodiments of the invention examples of which are illustrated in the accompanying drawings.

FIG. 1 is a view for explaining a plasma display apparatus according to one embodiment of the present invention.

Referring to FIG. 1, the plasma display apparatus according to one embodiment of the present invention includes a plasma display panel 100 arranged in a matrix type such that m×n discharge cells 130 are connected to scan electrode lines Y1 to Ym, sustain electrode lines Z1 to Zm and address electrode lines X1 to Xn, a scan driver 2002 for driving the scan electrode lines Y1 to Ym, a sustain driver 300 for driving the sustain electrode lines Z1 to Zm, a data driver 400 for driving the address electrode lines X1 to Xn, and a control board 500 for supplying each of the drivers 200, 300 and 400 a control signal based on display data (D), a horizontal synchronization signal (H), a vertical synchronization signal (V), a clock signal, and the like, which are input from the outside.

The scan driver 200 sequentially supplies a reset pulse for uniformalizing initialization states of all the discharge cells, a scan pulse (or address pulse) for selecting cells to be discharged, and a sustain pulse for representing gray scale in accordance with the number of discharges to the scan/sustain electrode lines Y1 to Ym, thereby sequentially scanning the discharge cells 130 in line unit and maintaining a discharge in each of the m×n discharge cells 130.

The sustain driver 300 supplies all the sustain electrode lines Z1 to Zm a sustain pulse alternating with the sustain pulse to be supplied to the scan electrode lines Y1 to Ym, thereby generating a sustain discharge in the selected discharge cell.

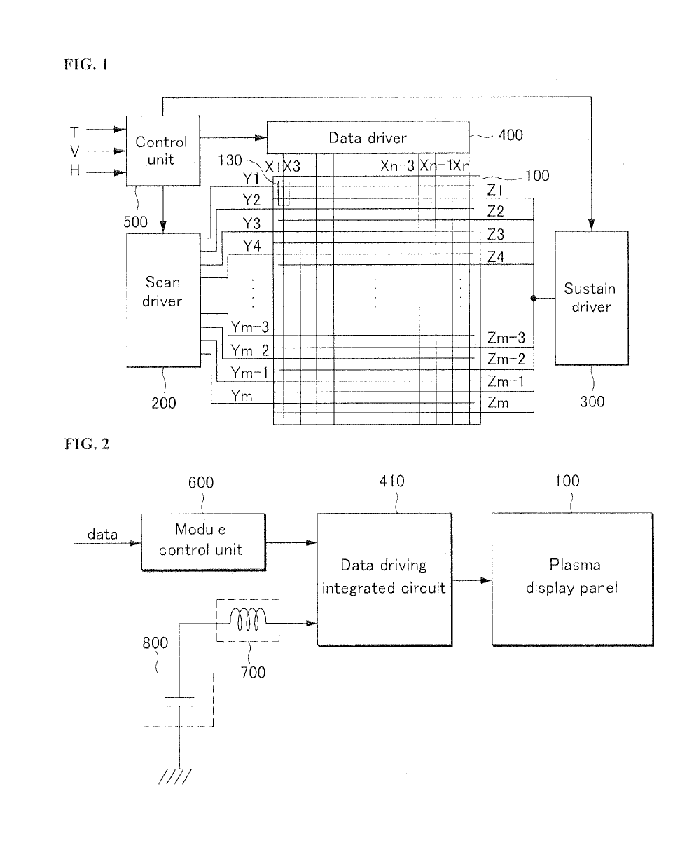

The data driver 60 supplies a data pulse synchronized with the scan pulse supplied to the scan electrode lines Y1 to Ym to the address electrode lines X1 to Xn, thereby selecting cells to be discharged. The data driver 60 adopts an energy recovery circuit to supply a data pulse. A detailed description thereof will be made in FIG. 2 below.

FIG. 2 is a view for explaining some parts of a data driver according to one embodiment of the present invention.

Referring to FIG. 2, the data driver according to one embodiment of the present invention includes a module control unit, a data driving integrated circuit, a resonance forming unit, and an energy storage unit.

The module control unit 600 controls a charging/discharging circuit for supplying or recovering charge/discharge currents to or from an address electrode by determining whether there is an operation for supplying or recovering charge or discharge currents according to a data signal.

The data driving integrated circuit 410 supplies a data voltage and a reference voltage to the address electrodes during an address period according to a data pulse, and forms a path for supplying or recovering charge or discharge currents to or from the address electrodes. A detailed description thereof will be made through various embodiments.

The energy storage unit 800 is connected to a data driving integrated circuit 410 to supply or recover charge or discharge currents for forming a data pulse to or from the address electrodes. For this, the energy storage unit 800 may include a capacitor Cs.

The resonance forming unit 700 is positioned between the data driving integrated circuit 410 and the energy storage unit 800 and resonate charge or discharge currents for forming a data pulse to supply or recover them to or from the address electrodes. For this, the resonance forming unit 700 may include an inductor L.

The plasma display panel 300 includes a plurality of address electrodes for including a phosphor layer in discharge cells defined by barrier ribs and supplying a driving pulse to the discharge cells. A detailed description thereof will be made later.

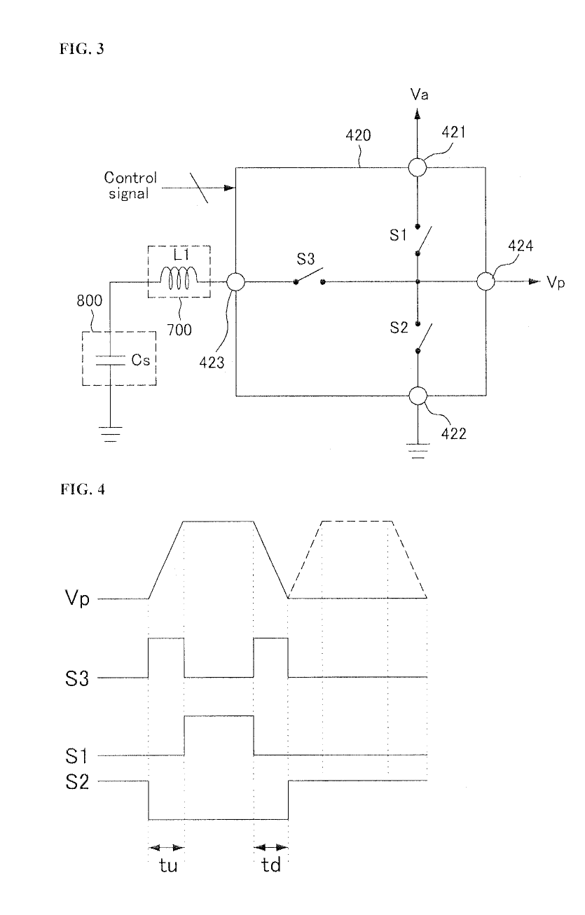

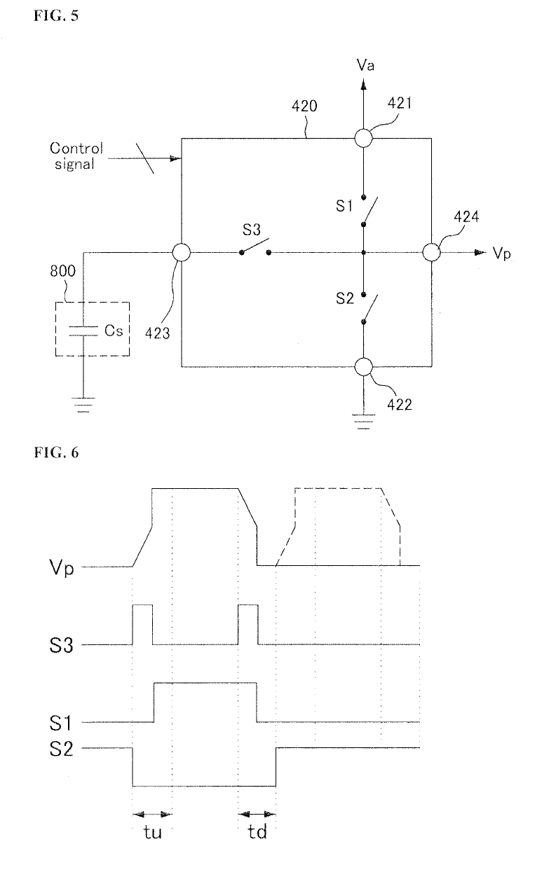

FIG. 3 is a view for explaining a data driving integrated circuit for a plasma display panel according to a first embodiment of the present invention. FIG. 4 is a view for explaining the operation of the data driving integrated circuit for a plasma display panel according to the first embodiment of FIG. 3.

Referring to FIG. 3, the data driving integrated circuit 420 according to the first embodiment of the present invention may include a first power input node 421, a second power input node 422, an output node 424, and a connection terminal 423.

Here, the output node 424 is connected to address electrodes X of the plasma display panel. The first power input node 421 is connected to a data voltage Va supply source (not shown), and is supplied with a data voltage Va during an address period according to a data pulse. The second input node 422 is grounded, and is supplied with a reference voltage during the address period. The connection terminal 423 is connected to a charging/discharging circuit for supplying or recovering charge or discharge currents to or from the address electrode X.

The charging/discharging circuit is formed by serially connecting an inductor L1 and 700 and a capacitor Cs and 800, and the connection terminal 423 is connected to the other node of the inductor L1 and 700, and the other node of the capacitor Cs and 800 is grounded.

A first switching device S1 may be arranged between the output node 424 and the first power input node 421, and a second switching device S2 may be arranged between the output node 424 and the second power input node 422.

The first switching device S1 forms a path between the output node 424 and the first power input node 421 so that a data voltage Va to be inputted to the first power input node 421 cab be transmitted to the address electrodes X via the output node 424.

The second switching device S2 forms a path between the output node 424 and the second power input node 422 so that a reference voltage to be inputted to the second power input node 422 can be transmitted to the address electrode via the output node 424. The reference voltage is implemented by a ground voltage GND.

The first switching device S1 and the second switching device S2 are switched on and off in an alternating manner. That is, if the first switching device S1 is turned on, the second switching device S2 is turned off, while if the first switching device S1 is turned off, the second switching device S2 is turned on.

If a voltage to be inputted to the address electrodes X from the first power input node 421 or the second power input node 422 via the output node 82 is in a high impedance state, a third switching device S3 for forming a path between the connection terminal 423 and the output node 424 may be arranged between the output node 424 and the connection terminal 423. Herein, the high impedance state means that digital data is not in a logic high or logic low state, but in a state of tu or td of FIG. 4.

Referring to FIG. 4, firstly, in the initial stage, the second switching device S2 is turned on, and the first switching device S1 and the third switching device S3 are turned off, and the capacitor Cs and 800 is charged with a voltage of Va/2. The reference voltage GND is supplied to the address electrodes by turning on the second switching device S2.

When the second switching device S2 is turned off and the first switching device S1 is turned on, they are brought to a high impedance state between the switching-off operation and the switching-on operation. If the third switching device S3 is turned on by using the high impedance state, a rising voltage is supplied to the address electrodes X by a resonance operation of the capacitor Cs and the inductor L1.

If the first switching device S1 is turned on, the third switching device S3 is turned off, and the data voltage Va is supplied to the address electrodes X via the output node 424.

Afterwards, even when the first switching device S1 is turned on, and the second switching device S2 is turned on, a high impedance state exists. If the third switching device S3 is turned on by using the high impedance state, the voltage of the plasma display panel is recovered and charged in the capacitor Cs.

FIG. 5 is a view for explaining a data driving integrated circuit for a plasma display panel according to a second embodiment of the present invention. FIG. 6 is a view for explaining the operation performed by the data driving integrated circuit for a plasma display panel according to the second embodiment of FIG. 5.

Herein, the components of the data driving integrated circuit 420 for a plasma display panel according to the second embodiment is identical to those of the data driving integrated circuit 420 for a plasma display panel of FIG. 3, so they are given the same reference numerals.

As shown in FIG. 5, the data driving integrated circuit for a plasma display panel according to the present invention is formed by removing the inductor L1 from the data driving integrated circuit for a plasma display panel of FIG. 3, connecting one end of the capacitor Cs to the connection terminal 423, and then grounding the other end of the capacitor Cs. In this case, as shown in FIG. 6, it is possible to reduce the volume of the data driving integrated circuit 420 and the time of the high impedance state, i.e., tu and td. A detailed description thereof is substantially identical to the description of FIGS. 3 and 4, so it will be omitted here.

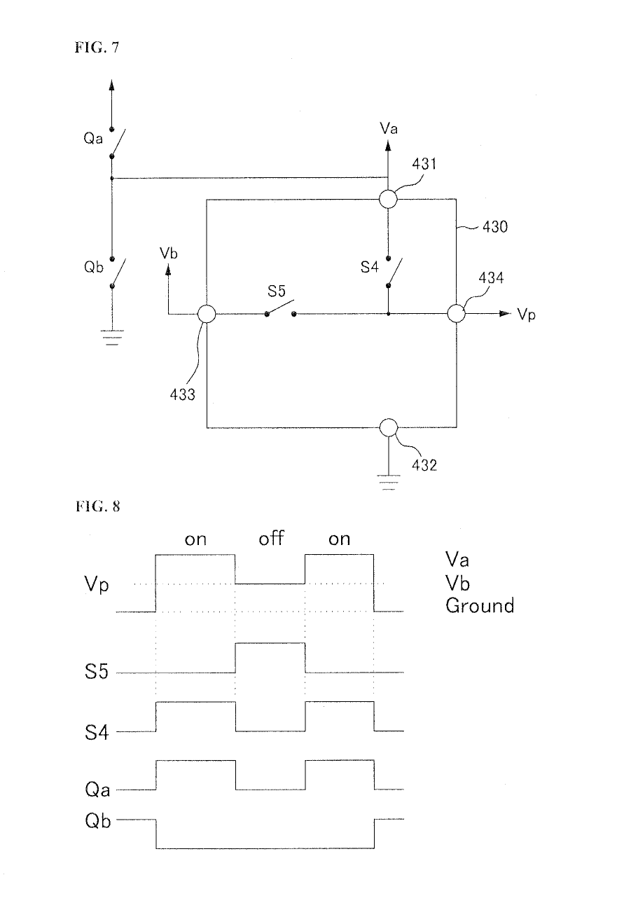

FIG. 7 is a view for explaining a data driving integrated circuit for a plasma display panel according to a third embodiment of the present invention. FIG. 8 is a view for explaining the operation performed by the data driving integrated circuit for a plasma display panel according to the third embodiment of FIG. 7.

Referring to FIG. 7, the data driving integrated circuit 430 according to the third embodiment of the present invention may include a third power input node 431, a fourth power input node 433, a fifth power input node 432, and an output node 434.

Here, the output node 434 is connected to address electrodes X of the plasma display panel. The third power input node 431 may be connected to a predetermined circuit for selectively receiving a data voltage Va and a reference voltage. The predetermined circuit connected to the third power input node 321 may be arranged to a data power switching device Qa and a reference voltage switching device Qb.

One end of the data power switching device Qa is connected to a data power source for supplying a data voltage Va, and the other end thereof is connected to one end of the reference voltage switching device Qb. The other end of the reference voltage switching device Qb is connected to a ground level voltage GND, and the third power input node 431 is connected to a common node of the data voltage switching device Qa and the reference voltage switching device Qb.

The fifth power input node 432 is grounded. The fourth power input node 433 is connected to a bias source (not shown), and a bias voltage Vb lower than the data voltage Va is supplied by the bias source during the address period according to a data pulse. The reference voltage is implemented by a ground voltage GND. The bias voltage vb is set to a voltage which is higher than the reference voltage and lower than the data voltage Va.

A fourth switching device S4 may be arranged between the output node 434 and the third power input node 431. No switching device exists between the output node 434 and the fifth power input node 432 unlike in the data driving integrated circuit for a plasma display panel of FIGS. 3 and 5. The fourth switching device S4 forms a path between the output node 434 and the third power input node 431 so that the data voltage Va and reference voltage inputted to the third power input node 431 can be transmitted to the address electrodes X via the output node 434.

If the data power switching device Qa is turned on, the fourth switching device S4 can be turned on to supply the data voltage Va to the address electrodes X. If there is a need to supply a power of a ground voltage level GND to the third power input node 431 in an interval except for the interval for supplying a data voltage Va, for example, in a sustain interval, it is made possible to turn on the reference voltage switching device Qb to supply the reference voltage GND to the address electrodes X.

Between the output node 434 and the fourth power input node 433, a fifth switching device S5 may be arranged to form a path between the fourth power input node 433 and the output node 434 if a voltage to be inputted to the address electrodes X from the third power input node 431 via the output node 434 is blocked by turning off the fourth switching device S4. If the fourth switching device S4 is turned off and the fifth switching device S5 is turned on, the supplying of the data voltage Va and the reference voltage GND is blocked, and the voltage supplied to the address electrodes X decreases from Va to Vb, as shown in FIG. 8, via the output node 434 by the supplying of a bias voltage Vb. Accordingly, the node-to-node between the fourth switching device S4 and the fifth switching device S5 becomes Va−Vb to thus drive the address electrodes X by an internal pressure lower than the conventional internal pressure.

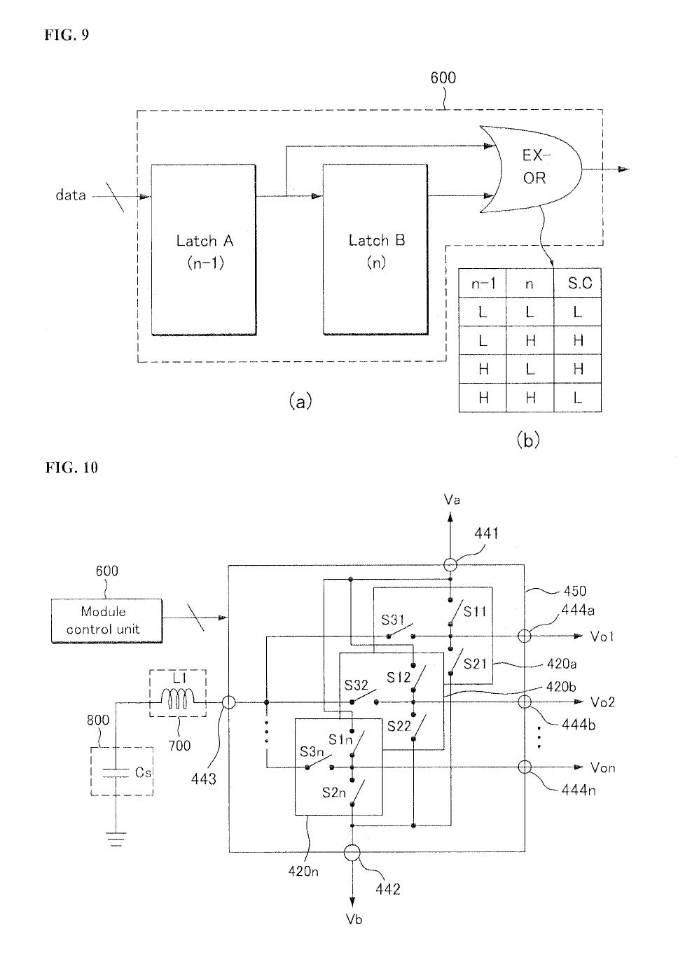

FIG. 9 is a view for explaining a module control unit according to one embodiment of the present invention.

Referring to (a) of FIG. 9, the module control unit 600 includes an exclusive OR-operation gate. The module control unit 600 controls a data driving circuit module by detecting a change of data signals of n−1 and n calculated according to the exclusive OR-operation gate.

Typically, the data driving integrated circuit performs latch control in order to simultaneously output input data signals. In one embodiment of the present invention, two latch controls are used, and a change of data signals of n−1 and n can be detected through the exclusive OR-operation gate.

In other words, according to the operational result obtained by operating a data signal corresponding to two scan lines by the exclusive OR-operation gate, it can be determined whether the third switching device S3 of FIGS. 3 and 5 included in the data driving circuit module or the fifth switching device S5 of FIG. 7 performs a turn-on operation or a turn-off operation.

(b) represents the operation the exclusive OR-operation gate. For example it is assumed that latch control A outputs a data signal of n−1 and latch control B outputs a data signal of n. If the data signal of n−1 and the data signal of n have the same high level or low level, a low level data signal is outputted through the exclusive OR-operation gate.

Alternately, the data signal of n−1 and the data signal of n have a different level from each other. For example, if the data signal of n−1 has a high level and the data signal of n has a low level or the data signal of n−1 has a low level and the data signal of n has a high level, a high level data signal is outputted through the exclusive OR-operation gate. Based upon the operational result of the exclusive OR-operation gate, it can be found out whether the third switching device S3 or the fifth switching device S5 are to perform a turn-on operation or a turn-off operation.

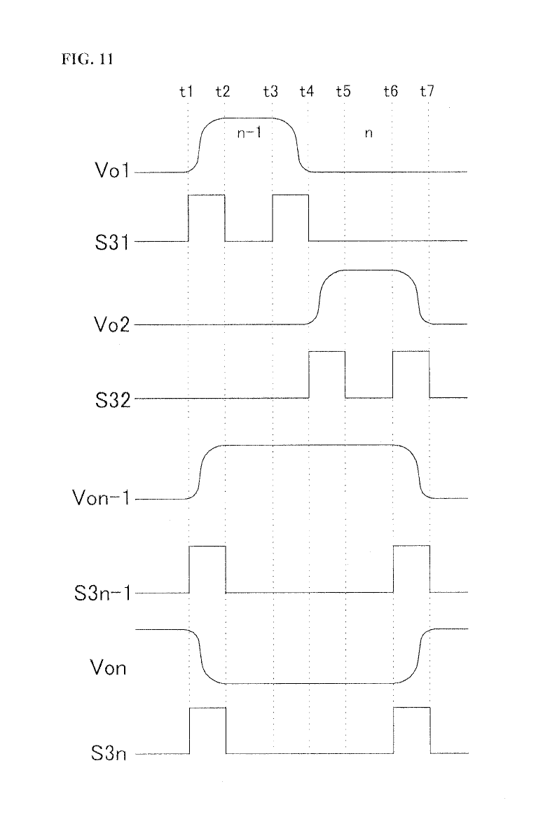

FIG. 10 is a view for explaining a data driving integrated circuit for a plasma display panel according to a fourth embodiment of the present invention. FIG. 11 is a view for explaining the operation performed by the data driving integrated circuit for a plasma display panel according to the fourth embodiment of FIG. 10.

Referring to FIG. 10, the data driving integrated circuit for a plasma display panel according to the fourth embodiment may have a plurality of data driving circuit modules formed therein.

A first data driving circuit module 420a supplies a first data voltage and a second data voltage to a first address electrode during an address period according to a first data pulse, and forms a path for supplying or recovering charge or discharge currents to or from the first address electrode.

A second data driving circuit module 420b supplies a data voltage or a reference voltage to a second address electrode during an address period according to a second data pulse, and forms a path for supplying or recovering charge or discharge currents to or from the second address electrode.

The first data driving circuit module 420a and the second data driving circuit module 420b each comprise a first power input node for receiving a first data voltage during an address period according to a first data pulse and a second data pulse, a second power input node for receiving a second data voltage during the address period, an output node to be connected to address electrodes, a connection terminal to be connected to a charging/discharging circuit for supplying or recovering charge/discharge currents to or from the address electrodes, first switching devices S11, S12, . . . S1n for switching between the first power input node and the output node so that a voltage inputted to the first power input node or the second power input node can be outputted to the address electrodes during the address period according to a first data pulse and a second data pulse, second switching devices S21, S22, . . . , S2n for switching between the second power input node and the output node, and third switching devices for connecting the connection terminal and the output node if the voltage inputted to the address electrodes from the first power input node or the second power input node is in a high impedance state.

The first data driving circuit module 420a and the second data driving circuit module 420b explained so far are included in the data driving integrated circuit 450.

Here, the data driving integrated circuit 450 is comprised of switching devices alone, which makes it easier to configure it as a single integrated circuit (IC).

The module control unit 600 controlling the data driving integrated circuit 450 controls such that charge or discharge currents for forming a second data pulse may be supplied to the second address electrode before recovering charge or discharge currents for forming a first data pulse from the first electrode according to a data signal, or such that charge or discharge currents for forming a data pulse may be recovered from the first electrode before recovering charge or discharge currents for forming a second data pulse from the second address electrode according to a data signal.

The energy storage unit 800 is connected to the data driving integrated circuit 450 to supply charge or discharge currents for forming a first data pulse and a second data pulse to the first address electrode and the second address electrode or recover them from the first address electrode and the second address electrode.

The resonance forming unit 700 is positioned between the data driving integrated circuit 450 and the energy storage unit 700 and resonates charge or discharge currents for forming a first data pulse and a second data pulse to supply them to the first address electrode and the second address electrode, respectively, or recover them from the first electrode and the second electrode, respectively.

The operation of the data driving integrated circuit 450 explained so far will be described below.

Referring to FIG. 11, Vo1 represents a case in which a data signal is converted from high to low at n−1 and n. The third switching device S31 receives charge or discharge currents for forming a first data pulse from the energy storage unit 800 to supply them to the address electrodes, or receives charge or discharge currents for forming a first data pulse from the address electrodes to recover them to the energy storage unit. By the operation of the third switching device S31, charge or discharge currents are supplied from the energy storage unit 800 to the first address electrode, or charge or discharge currents are recovered from the address electrodes to the energy storage unit 800.

Vo1 represents a case in which a data signal is converted from low at n−1 to high at n, Like Vo1, Vo2 also can obtain the effect of supplying or recovering charge or discharge currents by the turn-on or turn off operation of the third switching device S32.

Von−1 represents a case in which a data signal is kept high at n−1 and n. In this way, when a data signal is kept high, the third switching device S3n−1 is not operated. This is because if the third switching device S3n−1 is operated even if a data signal is not changed, unnecessary power consumption may occur.

Due to this reason, in Von, too, even when a data signal is kept low, the third switching device S3n is not operated. Resultantly, in case of a change in data signal, the third switching devices S31, S32, . . . , S3n is operated only when the data signal is changed from high to low or from low to high, thereby obtaining an optimized driving efficiency of all the discharge cells.

Especially, when a data signal is changed from low to high, the third switching devise S31, S32, . . . , S3n are turned on to supply charge or discharge currents to the address electrodes from the energy storage unit 800. When the data signal is changed from high to low, the third switching devices S31, S32, . . . , S3n are turned on to recover charge or discharge currents to the energy storage unit from the address electrodes.

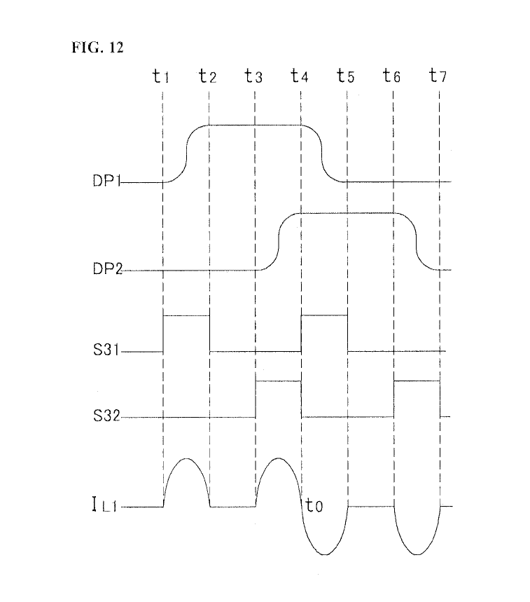

FIG. 12 is a view for explaining another operation performed by the data driving integrated circuit for a plasma display panel according to the fourth embodiment of the present invention.

First, it is assumed that the voltage charged in the plasma display panel including address electrodes before a period t1 is 0 V and ½ V of a data voltage is charged in the energy storage unit 800.

The period from t1 to t2 is a period in which chare or discharge currents for forming a first data pulse DP1 are supplied through the energy storage unit 800 to the first address electrodes. By turning on the third switching device S31, a supply current path is formed which consists of the energy storage unit 800, the resonance forming unit 700, the third switching device S31, and the first address electrode. The charge or discharge currents stored in the energy storage unit 800 rises from a reference voltage GND to a data voltage Va by LC resonance of the resonance forming unit 700 and the panel. A second data pulse DP2 is a period in which the reference voltage GND is supplied to the second address electrode. Accordingly, the second switching device S21 for receiving the reference voltage GND is turned on.

The period from t2 to t3 is a period in which a data voltage Va, i.e., the highest voltage of the first data pulse DP1, is supplied to the first address electrode. Accordingly, the first switching device S11 for receiving the data voltage Va is turned on. A second data pulse DP2 is a period in which the reference voltage GND is continuously supplied to the second address electrode.

The period from t3 to t4 is a period in which the first data pulse DP1 continuously maintains the data voltage Va, and a period in which charge or discharge currents for forming a second data pulse DP2 are supplied to the second address electrode through the energy storage unit. By turning on the third switching device S32, a supply current path is formed which consists of the energy storage unit 800, the resonance forming unit 700, the third switching device S32, and the second address electrode. The charge or discharge currents stored in the energy storage unit 800 rises from a reference voltage GND to a data voltage Va by LC resonance of the resonance forming unit 700 and the panel.

The period from t4 to t5 is a period in which charge or discharge currents for forming the first data pulse DPI are supplied from the first address electrode and recovered to the energy storage unit 800. By turning on the third switching device S31, a supply current path is formed which consists of the first address electrode, the third switching device S31, the resonance forming unit 700, and the energy storage unit 800. The charge or discharge currents stored in the first address electrode falls from a data voltage Va to a reference voltage GND y LC resonance of the resonance forming unit 700 and the energy storage unit 800. A data voltage Va, i.e., the highest voltage of the second data pulse DP2 is supplied to the second address electrode. Accordingly, the third switching device S31 for receiving a data voltage Va is turned on.

The period from t5 to t6 is a period in which the reference voltage GND, i.e., the lowest voltage of the first data pulse DP1, is supplied to the first address electrode. Accordingly, the first switching device S21 for receiving the reference voltage GND is turned on. A second data pulse DP2 is a period in which the data voltage Va is continuously maintained.

The period from t6 to t7 is a period in which the reference voltage GND of the first data pulse DPI is continuously supplied to the first address electrode, and a period in which charge or discharge currents for forming a second data pulse DP2 are supplied to the second address electrode and recovered to the energy storage unit 800, By turning on the third switching device S32, a supply current path is formed which consists of the second address electrode, the third switching device S32, the resonance forming unit 700, and the energy storage unit 800. The charge or discharge currents stored in the second address electrode falls from a data voltage Va to a reference voltage GND by LC resonance of the resonance forming unit 700 and the energy storage unit 800.

In the period after t7, the periods from t1 to t7 explained so far are repeated.

Charge or discharge currents for forming a second data pulse DP2 are supplied to the second address electrode before recovering charge or discharge currents for forming a first data pulse DP1 from the first electrode, or charge or discharge currents for forming a first data pulse DP1 are recovered from the first electrode before recovering charge or discharge currents for forming a second data pulse DP2 from the second address electrode.

Accordingly, the first data pulse DP1 and the second data pulse DP2 overlap with each other. Therefore, the address period is reduced as much as the period in which the first data pulse DP1 and the second data pulse DP2 overlap with each other. By reducing the address period, the sustain period is increased as much. The longer the sustain period, the higher the brightness, thereby improving the sustain margin.

Based upon the operation explained so far, it can be seen that the third switching devices S31, S32, . . . , S3n performs a high impedance function. A high impedance means a state in which a connection is made to neither high nor low. The period for operating the high impedance is a period in which the third switching devices S31, S32, . . . , S3n are turned on. In the actual driving, they serve to supply charge or discharge currents of the energy storage unit 800 to the address electrodes by using the resonance forming unit 700. Alternately, they are connected to the energy storage unit 800 and serves to recover charge or discharge currents of the address electrodes to the energy storage unit 800 by using the resonance forming unit 700.

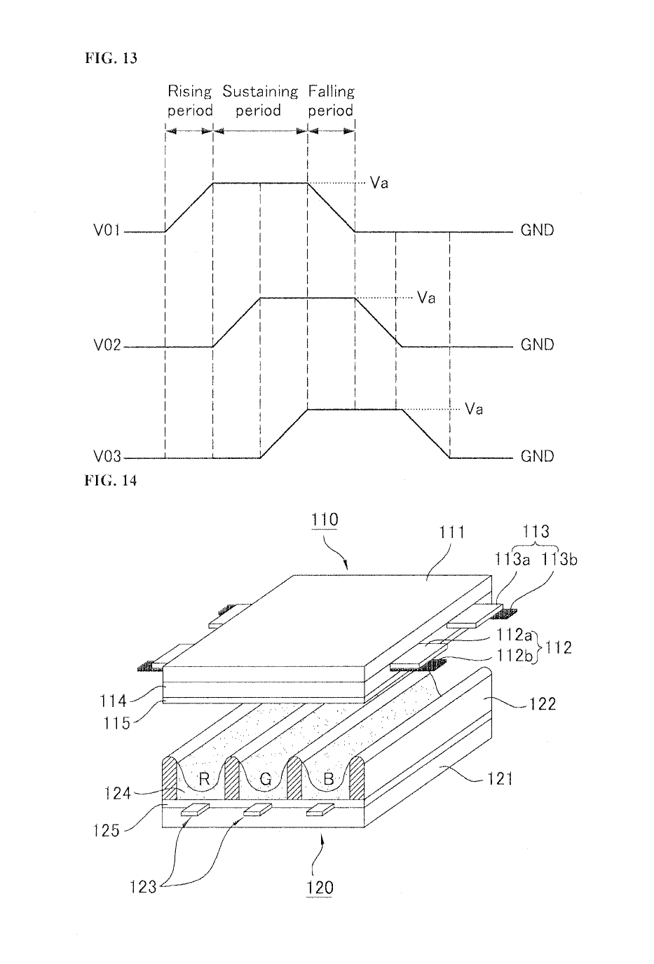

FIG. 13 is a view showing a data pulse according to one embodiment of the present invention.

In FIG. 13, the parts overlapping with the parts explained so far are omitted. Referring to FIG. 13, the first data pulse DP1 and the second data pulse DP2 each comprise a rising period for rising from a second data voltage to a first data voltage Va, a sustaining period for sustaining the first data voltage Va, and a falling period for falling from the first data voltage Va to the second data voltage.

The sustaining period for sustaining the first data voltage Va, i.e., the highest voltage of the first data pulse DP1 overlaps with the rising period for rising from the second data voltage to the first data voltage Va. Accordingly, the rising period of the second data pulse DP2 starts before the falling period of the first data pulse DP1 starts. Such overlapping can reduce the address period. By reducing the address period, the sustain period is increased as much. The longer the sustain period, the higher the brightness, thereby improving the sustain margin.

Preferably, the first data voltage is substantially higher than 50 V and lower than 70 V, and the second data voltage is substantially higher than the ground voltage level and lower than the first data voltage.

FIG. 14 is a view for explaining a structure of a plasma display panel in a plasma display apparatus according to one embodiment of the present invention.

As illustrated in FIG. 14, the plasma display panel 100 includes a front panel 110 and a rear panel 120 which coalesce with each other at a given distance therebetween. The front panel 110 includes a front substrate 111 on which a scan electrode 112 and a sustain electrode 113 are positioned parallel to each other. The rear panel 120 includes a rear substrate 121 on which an address electrode 123 is positioned to intersect the scan electrode 112 and the sustain electrode 113.

The scan electrode 112 and the sustain electrode 113 generate a mutual discharge therebetween in a discharge cell and maintain a discharge of the discharge cell.

A tight transmittance and an electrical conductivity of the scan electrode 112 and the sustain electrode 113 need to be considered so as to emit light produced inside the discharge cells to the outside and to secure the driving efficiency. Accordingly, the scan electrode 112 and the sustain electrode 113 each include transparent electrodes 112a and 113a made of a transparent material, for instance, indium-tin-oxide (ITO) and bus electrodes 112b and 113b made of a metal material.

An upper dielectric layer 114 covering the scan electrode 112 and the sustain electrode 1L3 is positioned on the front substrate 111 on which the scan electrode 112 and the sustain electrode 113 are positioned. The upper dielectric layer 114 limits discharge currents of the scan electrode 112 and the sustain electrode 113 and provides electrical insulation between the scan electrode 112 and the sustain electrode 113.

A protective layer 115 is positioned on an upper surface of the upper dielectric layer 114 to facilitate discharge conditions. The protective layer 115 may be formed of a material with a high secondary electron emission coefficient, for instance, magnesium oxide (MgO).

The address electrode 123 positioned on the rear substrate 121 applies a data signal to the discharge cell.

A lower dielectric layer 125 covering the address electrode 123 is positioned on the rear substrate 121.

Barrier ribs 122 are positioned on the lower dielectric layer 125 to partition the discharge cells. A phosphor 124 for emitting visible light for an image display during an address discharge is positioned inside the discharge cells partitioned by the barrier ribs 122. The phosphor 124 may include red (R), green (G) and blue (B) phosphors.

A discharge occurs inside the discharge cells by supplying driving signals to the scan electrode 112, the sustain electrode 113 and the address electrode 123, and thus an image is displayed on the plasma display panel 100.

Since FIG. 14 illustrated only an example of the plasma display panel applicable to the exemplary embodiment, the exemplary embodiment is not limited thereto.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data driving integrated circuit for a plasma display panel, comprising:
a first power input node for receiving a data voltage during an address period according to a data pulse;
a second power input node for receiving a reference voltage during the address period;
an output node to be connected to address electrodes;
a connection terminal to be connected to a charging/discharging circuit for supplying or recovering charge/discharge currents to or from the address electrodes;
a first switching device for switching between the first power input node and the output node so that a voltage inputted to the first power input node or the second power input node is outputted to the address electrodes during the address period according to a data pulse;
a second switching device for switching between the second power input node and the output node; and
a third switching device for connecting the connection terminal and the output node if the voltage inputted to the address electrodes from the first power input node or the second power input node is in a high impedance state.

2. The data driving integrated circuit of claim 1, wherein the connection terminal is connected to one end of a resonance forming unit, and the other end of the resonance forming unit is serially connected to an energy storage unit with one end grounded.

3. The data driving integrated circuit of claim 1 wherein the connection terminal is connected to the other end of the energy storage unit with one end grounded.

4. The data driving integrated circuit of claim 1, wherein the data driving integrated circuit comprises a module control unit controls a charging/discharging circuit for supplying or recovering charge/discharge currents to or from an address electrode by determining whether there is an operation for supplying or recovering charge or discharge currents according to a data signal.

5. The data driving integrated circuit of claim 1, wherein if the data signal is different from the previous data signal, the data driving integrated circuit supplies or recovers charge or discharge currents, while if the data signal is identical to the previous data signal, the data driving integrated circuit does not supply or recover charge or discharge currents.

6. A data driving integrated circuit for a plasma display panel, comprising:
a third power input node for selectively receiving a data voltage and a reference voltage during an address period according to a data pulse;
a fourth power input node for receiving a bias voltage lower than the data voltage and higher than the reference voltage during the address period;
an output node to be connected to address electrodes;
a fourth switching device for switching between the third power input node and the output node so that the data voltage or the reference voltage is outputted to the address electrodes during the address period according to a data pulse; and
a fifth switching device for switching between the fourth power input node and the output node so that a bias voltage is outputted to the address electrodes if the fourth power switching device is turned off.

7. The data driving integrated circuit of claim 6, wherein the third power input node is connected to one end of a data power switching device and one end of a reference voltage switching device, respectively.

8. The data driving integrated circuit of claim 7, wherein the other end of the data power switching device is connected to a data power source for supplying a data voltage, and the other end of the reference voltage switching device is grounded.

9. A plasma display apparatus, comprising:
a plasma display panel including a first address electrode and a second electrode;
a data driving integrated circuit including a first data driving circuit module and a second data driving module, the first data driving circuit module for supplying a first data voltage and a second data voltage to the first address electrode during an address period according to a first data pulse, and forming a path for supplying or recovering charge or discharge currents to or from the first address electrode, and the second data driving circuit module for supplying a data voltage or a reference voltage to the second address electrode during the address period according to a second data pulse, and forming a path for supplying or recovering charge or discharge currents to or from the second address electrode; and
a module control unit for controlling the data driving integrated circuit such that charge or discharge currents for forming a second data pulse may be supplied to the second address electrode before recovering charge or discharge currents for forming a first data pulse from the first electrode according to a data signal, or such that charge or discharge currents for forming a first data pulse may be recovered from the first electrode before recovering charge or discharge currents for forming a second data pulse from the second address electrode according to a data signal.

10. The plasma display apparatus of claim 9, wherein the plasma display apparatus comprise an energy storage unit which is connected to a data driving integrated circuit to supply or recover charge or discharge currents for forming a first data pulse and a second data pulse to or from the first address electrode and second address electrode.

11. The plasma display apparatus of claim 10, wherein the plasma display apparatus may comprise a resonance forming unit which is positioned between the data driving integrated circuit and the energy storage unit and resonates charge or discharge currents for forming a first data pulse and a second data pulse to supply or recover the same to or from the first address electrode and second address electrode.

12. The plasma display apparatus of claim 9, wherein if the data signal is different from the previous data signal, the data driving integrated circuit supplies or recovers charge or discharge currents, while if the data signal is identical to the previous data signal, the data driving integrated circuit does not supply or recover charge or discharge currents.

13. The plasma display apparatus of claim 9, wherein the first data pulse and the second data pulse overlap with each other.

14. The plasma display apparatus of claim 9, wherein the first data pulse and the second data pulse each comprise a rising period for rising from a second data voltage to a first data voltage, a sustaining period for sustaining the first data voltage, and a falling period for failing from the first data voltage to the second data voltage, and the rising period of the second data pulse starts before the falling period of the first data pulse.

15. The plasma display apparatus of claim 9, wherein the first data driving circuit module and the second data driving circuit module each comprises:
a first power input node for receiving a first data voltage during an address period according to a first data pulse and a second data pulse;
a second power input node for receiving a second data voltage during the address period;
an output node to be connected to address electrodes;
a connection terminal to be connected to a charging/discharging circuit for supplying or recovering charge/discharge currents to or from the address electrodes;
a first switching device for switching between the first power input node and the output node so that a voltage inputted to the first power input node or the second power input node is outputted to the address electrodes during the address period according to a first data pulse and a second data pulse;
a second switching device for switching between the second power input node and the output node; and
a third switching device for connecting the connection terminal and the output node if the voltage inputted to the address electrodes from the first power input node or the second power input node is in a high impedance state.

16. The plasma display apparatus of claim 14, wherein the first data voltage is substantially higher than 50 V and lower than 70 V, and the second data voltage is substantially higher than the ground voltage level and lower than the first data voltage.
